(19) United States
(12) Patent Application Publication
(10) Pub. No.: US 2012/0310882 A1
(43) Pub. Date: Dec. 6, 2012

(54) KEY VALUE DATA STORAGE

(75) Inventors: Jeremy M. Werner, Burlingame, CA (US); Julien Jacques Jalon, San Francisco, CA (US); Naveen Nalam, San Carlos, CA (US); Toby Charles Wood Paterson, San Francisco, CA (US)

(73) Assignee: Apple Inc., Cupertino, CA (US)

(21) Appl. No.: 13/486,516

(22) Filed: Jun. 1, 2012

Related U.S. Application Data
(60) Provisional application No. 61/493,333, filed on Jun. 3, 2011.

(51) Int. Cl. G06F 7/00; G06F 17/30

(52) U.S. Cl. 707/624; 707/691; 707/610; 707/E17.005; 707/E17.032

(57) ABSTRACT

Methods, systems, and apparatus, including computer programs encoded on a computer storage medium, for data synchronization. In general, one aspect of the subject matter described in this specification can be embodied in methods that include the actions of receiving a key-value pair from a first device, the key-value pair including a value corresponding to particular application data of the first device; notifying one or more other devices associated with the first device of the key value pair; receiving a request from a second device for the key-value pair; and sending the key-value pair to the second device.

### CROSS-REFERENCE TO RELATED APPLICATIONS

This application claims the benefit under 35 U.S.C. §119(e) of the filing date of U.S. Patent Application No. 61/493,333, for Key Value Data Storage, which was filed on Jun. 3, 2011, and which is incorporated here by reference.

### BACKGROUND

This specification relates to data storage.

Users can store data in a remote location, e.g., a network storage location, and retrieve the stored data at a later time. Users can also transfer data between devices. Typically, users share data with others through file transfer or sharing. For example, a user can identify a particular file to send to others, e.g., by e-mail or using a file transfer protocol. File sharing allows other users, e.g., on a network, to access files, however the files typically remain at their original location. Alternatively, files can be checked out from their original storage location by others, but typically the only user that can modify the file is the one that checked the file out.

Conventional systems also allow for users to synchronize data between the user's devices (e.g., a laptop computer and a mobile device). Often, only particular types of data are synchronized between devices or the synchronization has to be initiated by the user.

### SUMMARY

This specification describes technologies relating to key value data storage.

In general, one aspect of the subject matter described in this specification can be embodied in methods that include the actions of receiving a key-value pair from a first device, the key-value pair including a value corresponding to particular application data of the first device; notifying one or more other devices associated with the first device of the key value pair; receiving a request from a second device for the key-value pair; and sending the key-value pair to the second device.

Other embodiments of this aspect include corresponding systems, apparatus, and computer programs recorded on computer storage devices, each configured to perform the operations of the methods.

These and other embodiments can each optionally include one or more of the following features. The method further includes storing the received key-value pair. Prior to notifying the one or more other devices, determining whether the received key-value pair raises a conflict with one or more other stored key-value pairs. If a conflict is determined, sending a conflict notification to the first device along with data associated with one or more conflicting key value pairs. The method further includes receiving a conflict resolution from the first device.

In general, one aspect of the subject matter described in this specification can be embodied in methods that include the actions of receiving a first key-value pair from a running application, the first key-value pair including a value corresponding to particular application data; sending the first key-value pair to a remote location for storage according to a specified schedule; receiving a second key-value pair from the remote location for the application; and providing the second key-value pair to the application. Other embodiments of this aspect include corresponding systems, apparatus, and computer programs recorded on computer storage devices, each configured to perform the operations of the methods.

These and other embodiments can each optionally include one or more of the following features. Providing the new key-value pair to the application includes storing the new key-value pair if the application is not currently running

In general, one aspect of the subject matter described in this specification can be embodied in methods that include the actions of sending a key-value pair for an application to a remote location for storage; receiving notification of a conflict with another stored key-value pair including receiving information about the conflicting key-value pair; resolving the conflict; and notifying the remote location of a conflict winner. Other embodiments of this aspect include corresponding systems, apparatus, and computer programs recorded on computer storage devices, each configured to perform the operations of the methods.

These and other embodiments can each optionally include one or more of the following features. Resolving the conflict includes: determining that the key-value pairs do not represent an initial synchronization between devices; comparing timestamps for each key-value pair, the timestamp indicating the time the key-value pair was generated on a respective device; and selecting the key-value pair having the latest timestamp as the conflict winner. Resolving the conflict includes: determining that one of the key-value pairs represent an initial synchronization between devices; and selecting the key-value pair that is not identified as associated with an initial synchronization as the conflict winner.

In general, one aspect of the subject matter described in this specification can be embodied in apparatus including a computing device configured to provide: one or more applications; a key-value daemon for managing application key-value pairs including providing key-value pairs to a remote storage location, receiving key-value pairs from other devices for synchronization, and performing conflict resolution between key-value pairs; and a key-value cache for storing key-value pairs to be sent to remote storage or received from remote storage. Other embodiments of this aspect include corresponding systems, method, and computer programs recorded on computer storage devices.

Particular embodiments of the subject matter described in this specification can be implemented so as to realize one or more of the following advantages. Small pieces of data can be stored and synched with other devices as key-value pairs instead of separate files. Application specific key-value pairs can be securely stored and synchronized. Conflict resolution logic depends on whether the key-value pair is associated with an initial synchronization. Initial device synchronizations are processed to preserve application data on other devices.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram illustrating an example system for storing and synchronizing key value pairs.

FIG. 2 is a flow chart of an example process for synchronizing key-value pairs.

FIG. 3 is a flow chart of an example client process for storing and receiving updated key-value pairs.

FIG. 4 is a flow chart of an example process for conflict notification.

FIG. 5 is a flow chart of an example process for client side conflict resolution.

FIG. 6 is an example system architecture.

Like reference numbers and designations in the various drawings indicate like elements.

### DETAILED DESCRIPTION

Key-value pairs including particular application data as values can be stored and synchronized between devices (e.g., devices associated with a particular user or account). For example, the key-value pairs for an application can be stored externally to any user devices, e.g., a cloud or network storage. Additionally, the key-value pairs can be synchronized across one or more other user devices such that the key-value data can be incorporated into corresponding applications on multiple user devices. A user can have multiple devices having the same application, for example, a mobile device and a tablet device. When a user makes a change to the application instance on one device (e.g., modifying a setting), the same change can be synchronized to the application instance on the tablet device.

The external storage can identify conflicts between key-value pairs pushed to the external storage from different devices. Once notified of a conflict, a particular user device can resolve the conflict according to one or more conflict resolution processes to identify a winning key-value pair.

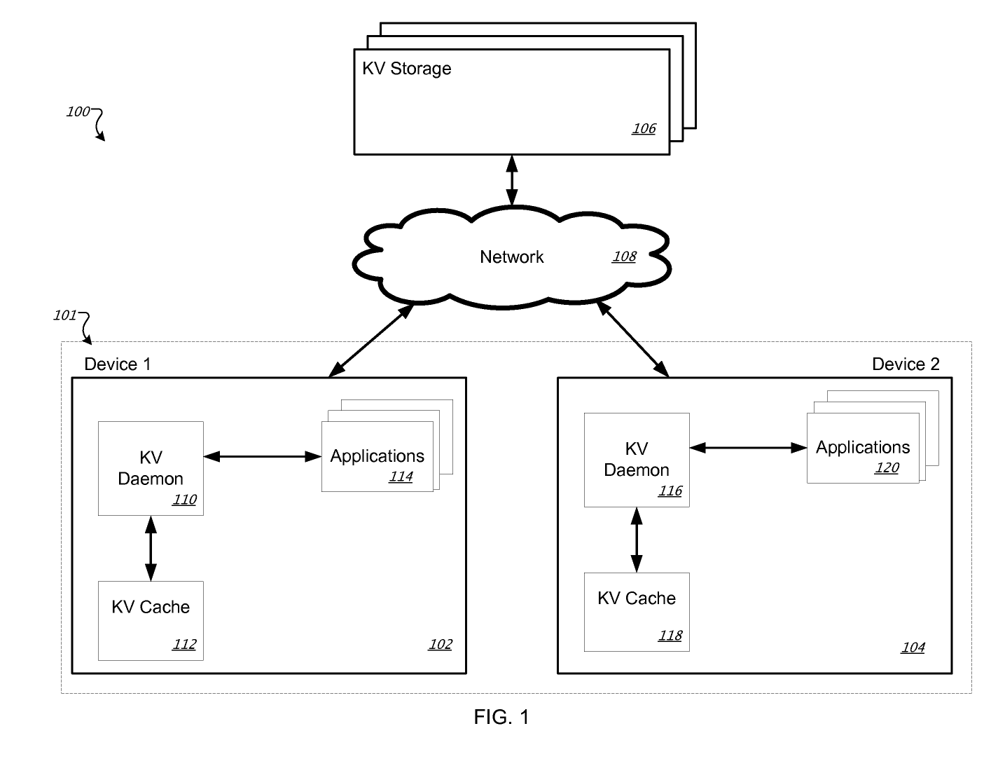

FIG. 1 is a diagram illustrating an example system 100 for storing and synchronizing key value pairs. The system 100 includes a first device 102, a second device 104, and a remote storage location 106.

The first device 102, second device 104, and remote storage location 106 are coupled together using one or more networks 108. Each of the first device 102 and the second device 104 can include, for example, one or more computing devices including desktop or laptop computing devices, mobile devices, tablet devices, personal data assistants, or other computing devices. In particular, each of the devices 102 and 104, for illustration, can be associated with a particular user or user account 101. However, the remote storage location 106 can be coupled to many other devices, not shown, that are associated with one or more different users or different user accounts.

The remote storage location 106 can be a single storage location or multiple storage locations. The remote storage location can include one or more computing devices including, for example, a server, a network addressed storage location, or a collection of computing devices, or as part of a cloud storage system presenting virtualized network storage.

The one or more networks 108 can include both wired and wireless networks. A network 108 can be, for example, part of a local area network, wide area network, or the Internet.

The first device 102 includes one or more applications 114, a key-value daemon 110, and a key-value cache 112. The second device 104 similarly includes one or more applications 120, a key-value daemon 116, and a key-value cache 118. The applications 114 and application 120 can include one or more of the same applications. The applications 114 can generate new key-value pairs based on changes to a running application. For example, a user can modify particular settings or configuration information for an application. Alternatively, a user can save particular data associated with the application (e.g., scores, ratings, etc.). While not limited to small pieces of data, the key-value pairs are typically small pieces of data not stored as files like documents or other larger pieces of data.

For example, the first device 102 can be a mobile device that includes as one of the applications 114 a stocks application. The stocks application provides stock information including, for example, stock price quotes, for various companies. A user can modify a listing of companies being presented. For example, the user can add a new stock to the listing. If the user modifies the listing, a new key-value pair can be generated that represents the new listing or the change in the listing. Other types of key-value data include listings of cities for a weather application, data identifying a last page read of an electronic book, etc.

A key-value pair is a data structure expressed in the form <key, value>, where the key is an identifier and the value is the data being stored in the key-value pair. The key can identify, for example, the application and the type of data stored in the associated value (e.g., that it is a stocks application stock listing). The value encodes the actual stocks listing in a form interpretable by the application. The key can also identify a particular user or user account. Consequently, key-value pairs can be stored separately by application and/or by user or user account.

When a new key-value pair is generated by an application 114, it is provided to the key-value daemon 110. The key-value daemon 110 can be a background application that operates continuously while the device is running The key-value daemon 110 receives key-value pairs from applications 114 as well as from the remote storage location 106. The key-value daemon 110 can include logic for as well as for resolving conflicts between key-value pairs from different devices, which will be described in greater detail below.

The key-value cache 112 allows the key-value daemon 110 to store both notifications and received key-value pairs. In some implementations, the key-value cache stores received key-value pairs from the applications 114 for a period of time according to particular storage criteria. Once the criteria have been satisfied, a group of one or more key-value pairs can be sent to the remote storage location 106. Key-value pairs can be sent as a group or batch, for example, to improve performance or to reduce network traffic. The criteria can include, for example, a period of time or a number of pending key-value pairs. The key-value cache 112 can be used to regulate the number and frequency of transactions between the key-value daemon 110 and the remote storage location 106. In some implementations, when updated key-value pairs are received from an application 114, the cache 112 can discard earlier received key-value pairs for that application stored in the cache 112. In some implementations, the cache 112 is sandboxed to protect the stored key-value data. The communication of key-value pairs between the applications 114 and the key-value daemon 110 can be encrypted.

Additionally, the key-value cache 112 can store key-value pairs received from the remote storage location 106. For example, if the corresponding application 114 is not running when a new key-value pair for that application is received, the key-value cache can store the key-value pair until the application is available (e.g., the application is running)

The key-value cache 112 can maintain a journal of last change for each key and the related “generation count” that provides an indication as to when the changes occurred as well as tracking which changes have already been incorporated. When the key-value daemon 110 notifies an application that the contents of the key-value cache 112 has changed, the application receives the journal and only consider changes that have a generation count greater than its last known generation count.

The remote storage location 106 receives key-value pairs from devices, e.g., the first device 102 and the second device 104 for storage and to provide synchronization. The key-value pairs can be securely stored. For example, containers for particular accounts can be generated on the remote storage location 106. Additionally, secure containers can further be generated for each application or application family according to specified permissions such that application specific key-value pairs are only provided to devices associated with the user account and having permission to access that application data.

The remote storage location 106 also provides notifications to the first device 102 and the second device 104. For example, when the first device 102 pushes a new key-value pair to the remote storage location 106, the remote storage location 106 can notify the second device 104 of the new key-value pair (e.g., if the second device 104 is associated with the same account and has the same application). The second device 104 can then request the corresponding key-value pair (e.g., immediately or at some later time) for incorporation with the corresponding application 120 of the second device 104.

For example, the notification can be sent to the key-value daemon 116 of the second device 104. The key-value daemon 116 can then request the key-value pair in response to the notification. The received key-value pair can be stored in the key-value cache 118 until provided to the corresponding application 120.

Thus, using the previous stocks application example, a key-value pair indicating a new stock listing can be sent from the first device 102 to the remote storage location 106. The remote storage location 106 both stores the key-value pair and sends a notification to the second device 104. The second device 104 can then request the key-value pair, for example using the key value daemon 116. They key-value pair can then be used to synchronize the stocks listing in the corresponding stocks application of the second device 104.

In some implementations, a conflict check is run when a new key-value pair is received to determine whether there is a conflicting key-value pair that has been received.

In some other implementations, key-value pairs are sent to the other devices in place of the notification. For example, key-value pairs can be automatically sent according to a particular policy or schedule. The key-value pairs can be sent only to those devices having permission to receive them, for example, belonging to the same user account, and having the same application. Permissions can be controlled by one or more policies that identify, for example, particular application access keys.

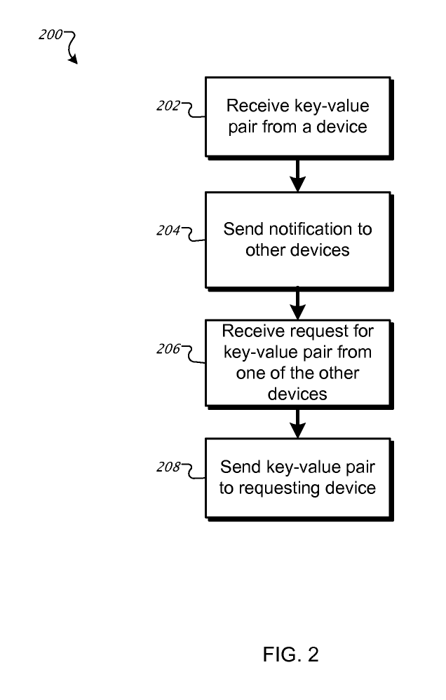

FIG. 2 is a flow chart of an example process 200 for synchronizing key-value pairs. The process 200 can be performed by one or more computing devices, for example, by the remote storage location 106 of FIG. 1.

A key-value pair is received from a device (step 202). Upon receipt the key-value pair can be stored and processed. The processing can include determining whether the newly received key-value pair results in a conflict. The processing can also include determining whether the key-value pair is authorized for storage. In some implementations, storing the key-value pair includes determining whether or not prior key-value pairs have been stored for the application or for the user account. For example, when no prior key-value pair has been stored, appropriate containers can be generated for storing application key-value pairs. When key-value pairs have been stored for the application, the key-value pair can be stored in an existing container.

A notification is sent to other devices (step 204). In particular, a notification of the newly available key-value pair is sent to one or more devices associated with the user or user account. For example, these can include other user devices such as mobile devices, tablet devices, etc. In some implementations, the notification includes an identification of the application for which the key-value pair is associated. The notification can indicate that a new key-value pair is available. These notifications can be limited to those devices having an application that has permission to read the key-value pairs (e.g., the same application). Additionally, only the application or applications with permission to read a particular key-value pair will be made aware of the new key-value pair. Thus, individual applications are prevented from seeing key-value pairs except those to which the application has permission to read. These permissions can be enforced, for example, by policies that require particular identifiers to establish access (e.g., each application can be assigned a particular identifier, for example, of the form “[developer].[application name]” that identifies which key-value pairs the application can read).

In some implementations, an identifier for an application can vary across platforms (e.g., an application can have a first identifier on a laptop and a second identifier on a mobile phone). However, when adding an application, permissions can be established allowing the application to read key-value pairs from corresponding applications having these alternative identifiers. One or more security policies can be used when adding applications to ensure that the permissions do not allow applications to access key-value information from applications that are not associated with the application.

A request is received for the key-value pair from one or more of the other devices (step 206). The request can specify one or more key-value pairs, e.g., from one or more prior notifications. Alternatively, the request can be for all available key-value pairs. For example, a particular device can request a number of key-value pairs based on specific retrieval criteria, for example, based on network connectivity to the remote storage location. In some implementations, the key-value daemon throttles updates with the remote storage location to control the amount and flow of data. Additionally, in some implementations, the remote storage location can request a delay from the device. The requested key-value pair is sent to the one or more requesting devices (step 208).

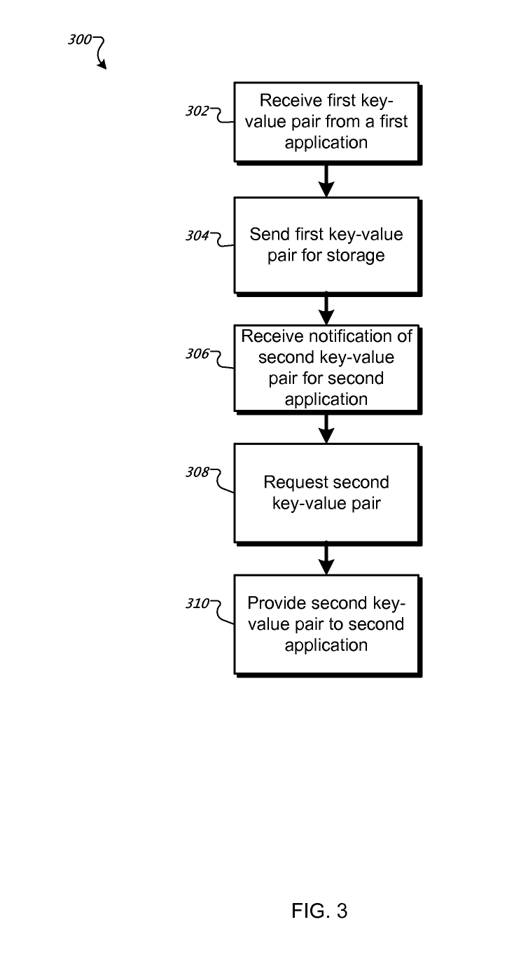

FIG. 3 is a flow chart of an example client process 300 for storing and receiving updated key-value pairs. The process 300 can be performed by one or more computing devices, for example, by the first device 102 of FIG. 1.

A first key-value pair is received from a first application (step 302). For example, a key-value daemon (e.g., key-value daemon 110) can receive key-value pairs from one or more applications (e.g., applications 114) on a device including the first application. The first application can be, for example, a stocks application where the first key-value pair was generated in response to a user modifying a stocks list. The key-value cache (e.g., key-value cache 112) maintains a generation count and a journal of last change for each key and the related generation count. Thus, the key-value daemon and key-value cache maintain an ordered record of changes to each key.

The first key-value pair is sent for storage (step 304). The first key-value pair can, for example, be pushed to a cloud storage or other remote storage location (e.g., remote storage location 106). In some implementations, the first key-value pair is sent for storage according to particular criteria. The first key-value pair can be placed in a cache (e.g., cache 112) until the criteria have been satisfied. For example, the criteria can include a schedule in which key-value pairs stored in the cache are pushed to the storage location periodically, for example, every hour, every four hours, etc. In another example, the criteria can include a threshold number of key-value pairs stored in the cache. Thus, a group of key-value pairs can be pushed to the storage location once a certain threshold number of key-value pairs have been added to the cache.

In some implementations, a combination of criteria is used. For example, a quantity threshold number of key-value pairs needed to trigger sending the key-value pairs can be overridden by an amount of time being reached without hitting the quantity threshold. For example, the criteria can be to send key-value pairs once 10 have been added to the cache, but if this threshold number is not reached within 6 hours, the key-value pairs are sent.

A notification is received for a second key-value pair for a second application (step 306). The notification can be received, for example, by the key-value daemon from the remote storage location. The remote storage location can send the notification in response to receiving the second key-value pair from another device.

The second application can be the same as the first application or a different application. For example, the second application can be a weather application. The second key-value pair can indicate a change in a listing of cities for which weather information is presented by the second application.

In some implementations, the key-value daemon notifies to the application that the key-value cache has changed. The application receives the journal from the key-value cache. In particular, only changes that have a generation count greater than its last known generation count are considered. The corresponding key-value pairs for these later changes can be requested from the key-value daemon.

The second key-value pair is requested (step 308). The key-value daemon can request the key-value pair according to specified criteria. In some implementations, to reduce network traffic, the key-value pair is requested once a specified number of notifications have been received. In some other implementations, to reduce latency, the request can be based on network connectivity of the device. For example, the key-value daemon can delay the request until within a Wi-Fi network rather than a cellular network.

The second key-value pair is provided to the second application (step 310). The key-value daemon provides the second key-value pair to the second application. The second application interprets the key-value pair in order to make appropriate changes to the second application (e.g., modifying a listing of cities or stocks based on the value). In some implementations, the second key-value pair is held in a cache until the second application is running and available to receive the second key-value pair. In particular, when the application is launched, it will read the key-value cache and retrieve the change journal if any. Once the application has acknowledged the changes, it asks the key-value daemon to discard the journal.

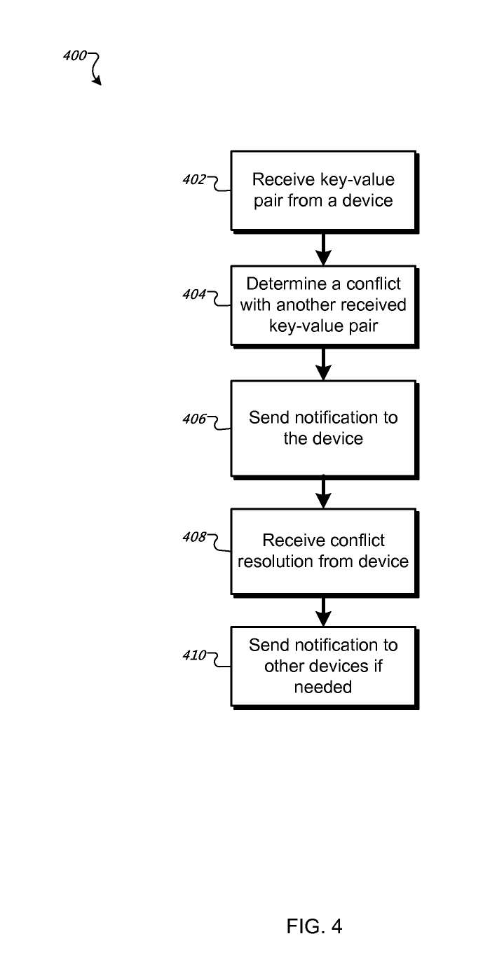

FIG. 4 is a flow chart of an example process 400 for conflict notification. The process 400 can be performed by one or more computing devices, for example, by the remote storage location 106 of FIG. 1.

A key-value pair is received from a device (step 402). The key-value pair can be received, for example, from a key-value daemon on the device that manages key-value pairs from applications on the device. In some implementations, there is a delay in sending the key-value pair. For example, the cache can hold key-value pairs until specified criteria are satisfied. In another example, the key-value pair can be received from an application while the device is not connected to the remote storage location (e.g., working offline, airplane mode, or because of reception or away from a network). In that scenario, the new key-value pairs cannot be sent to the remote storage location until a connection has been restored.

A determination is made that a conflict exists with another received key-value pair (step 404). Conflicts can be detected per key. A received key-value pair at the remote storage location includes a sequence value or other incremental identifier. This identifies a relative position of the particular key-value pair to other key-value pairs for the application. For example, each time the application generates a new key-value pair the identifier is incremented.

In some implementations, key-value pairs for an application are sent to the remote storage location from different devices contemporaneously with each other. For example, a key-value pair generated when the device is online can be sent to the remote storage location after the user has made another change to the application on another device. As a result, the remote storage location receiving the later sent key-value pair determines that the identifier indicates the key-value pair is out of sequence. This results in a conflict being determined for the respective key-value pairs. In some implementations, the sequence numbers are provided by the remote storage location after each change (e.g., key-value pair) is received.

A notification is sent to the device (step 406). The notification to the device indicates that the key-value pair sent to the remote storage location is out of sequence from another key-value pair received for the application. In some implementations, the remote storage location does not send any other notifications for the key-value pair to other devices until the conflict is resolved.

A conflict resolution is received from the device (step 408). The conflict resolution can identify a winning key-value pair that is to be synchronized across other devices. Notification is sent to other devices based on the conflict resolution (step 410). The notification of the winning key-value pair can supersede any prior notifications sent for a non-winning key-value pair from the conflict. The key-value pair can be provided to devices in response to a received request.

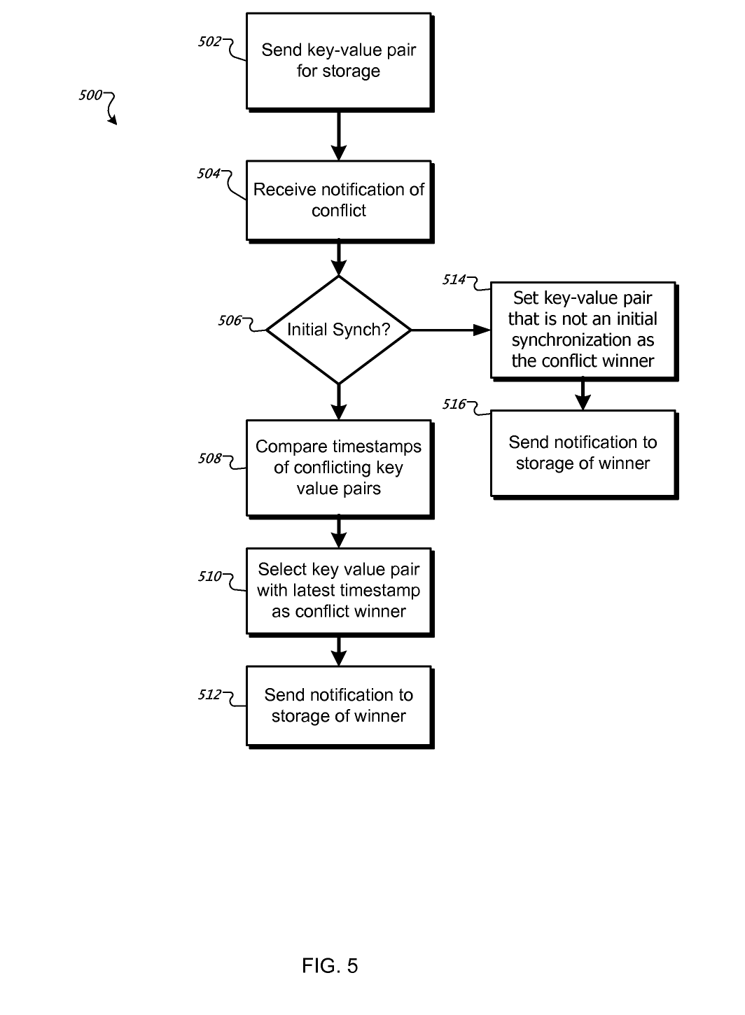

FIG. 5 is a flow chart of an example process 500 for client side conflict resolution. The process 500 can be performed by one or more computing devices, for example, by the first device 102 of FIG. 1.

A key-value pair is sent for storage (step 502). For example, a particular device can send the key-value pair using a key-value daemon that received the key-value pair from a particular application as described above.

A notification of a conflict is received (step 504). The notification indicates that the sent key-value pair is out of sequence relative to a key-value pair received from another device.

A determination is made as to whether one of the conflicting key-value pairs represents an initial synchronization (step 506). For example, when a new device is associated with the user or user account (e.g., the user purchases a new mobile device), the device has never been synchronized with other user devices. When sending key-value pairs to the remote storage location for the first time, an indication that it is an initial synchronization is included. The initial synchronization presents a problem because the new device may have default settings to applications that could override user modifications to applications if synchronized.

If the conflicting key-value pairs do not include a key-value pair from an initial synchronization, the timestamps associated with each respective key value pair are compared (step 508). The timestamps indicate the time in which the key-value pair was generated by the application, for example, when the user entered the change. This is in contrast to a time in which the key-value pair was uploaded to the remote storage location.

The key-value pair with the latest timestamp is selected as the conflict winner (step 510). The latest timestamp identifies the key-value pair for the most recent change to the application by the user. A notification of the conflict winner is sent to the remote storage location (step 512). In response to the notification, the remote storage location can send notifications to other devices indicating the winning key-value pair as an available key-value pair for incorporation by the corresponding applications on the other devices.

If the conflicting key-value pairs include a key-value pair from an initial synchronization, the key-value pair that is not an initial synchronization is the conflict winner (step 514). The reason behind that is that if a first device has already been synchronized to the remote storage location for a period of time and then later a new device is setup for synchronization, the key-value pairs pushed to the remote storage location by the first device are likely to be more valuable but will also have an older timestamp. A notification of the conflict winner is sent to the remote storage location (step 516). In response to the notification, the remote storage location can send notifications to other devices indicating the winning key-value pair as an available key-value pair for incorporation by the corresponding applications on the other devices. Once the initial synchronization has been completed, the newly added device will synchronize and resolve conflicts as described above for non-initial synchronization.

In some implementations, in response to a determination of an initial synchronization, a merge operation between the conflicting key-value pairs is performed. For example, the application can generate a new key-value pair representing the merged result that is then pushed to the remote storage location. As a result, instead of replacing the key-value for the device of the losing key-value pair, the content from the losing key-value pair is preserved.

In some implementations, the action in response to the conflict can vary depending on application specific preferences. Some applications can include instructions to merge conflicts while others replace conflicts with the winning key-value pair. For example, listings such as stock listings or weather cities can usually be merged while the last page read of an electronic book cannot.

In some implementations, a retention policy is used to determine when to delete key-value pairs from the remote storage location. For example, if a user deletes an application the corresponding key-value pairs in the remote storage location can be deleted as well. Alternatively, the key-value pairs can be retained indefinitely or for a specified period of time (e.g., 1 month from deletion of the corresponding application). In some implementations, a default policy is used. The default policy can be applied to all applications or can vary by application. In some other implementations, the retention policy is user specifiable. When user specified, a user interface can be provided to facilitate the user modification or creation of retention policies.

Key-value pairs can be limited in size. For example, the system can cap the amount of data in the value to a specified maximum size (e.g., 16 kilobytes). The size cap can allow for quick synchronization of key-value pairs between devices. The size cap also allows for an alternative mechanism for synchronizing particular types of data from file synchronization techniques. However, in some alternative implementations, the value of the key-value pair does not include a size limit. As such large amounts of data can be sent for storage and/or synchronization as key-value pairs. In some instances, entire files can be encoded as values in one or more key-value pairs.

In some implementations, the remote storage location is unnecessary. Key-value pairs can be synchronized between devices peer-to-peer. As such, key-value pairs are sent to one or more peer devices. The key-value pairs can be sent to all peer devices or peer devices can engage in a sequencing of key-value synchronization that reduces network traffic.

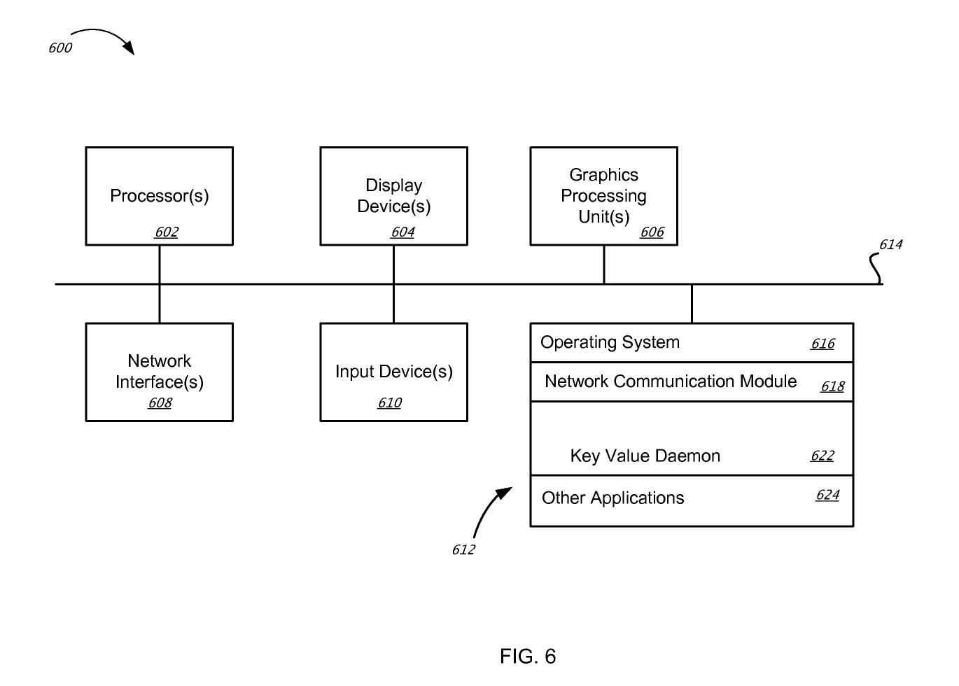

FIG. 6 is an example system architecture 600. The system architecture 600 is capable of performing operations for synchronization data between devices. The architecture 600 includes one or more processors 602 (e.g., IBM PowerPC, Intel Pentium 4, etc.), one or more display devices 604 (e.g., CRT, LCD), graphics processing units 606 (e.g., NVIDIA GeForce, etc.), a network interface 608 (e.g., Ethernet, FireWire, USB, etc.), input devices 610 (e.g., keyboard, mouse, etc.), and one or more computer-readable mediums 612. These components exchange communications and data using one or more buses 614 (e.g., EISA, PCI, PCI Express, etc.).

The term “computer-readable medium” refers to any medium that participates in providing instructions to a processor 602 for execution. The computer-readable medium 612 further includes an operating system 616 (e.g., Mac OS®, Windows®, Linux, etc.), a network communication module 618, a key-value daemon 622, and other applications 624.

The operating system 616 can be multi-user, multiprocessing, multitasking, multithreading, real-time and the like. The operating system 616 performs basic tasks, including but not limited to: recognizing input from input devices 610; sending output to display devices 604; keeping track of files and directories on computer-readable mediums 612 (e.g., memory or a storage device); controlling peripheral devices (e.g., disk drives, printers, etc.); and managing traffic on the one or more buses 614. The network communications module 618 includes various components for establishing and maintaining network connections (e.g., software for implementing communication protocols, such as TCP/IP, HTTP, Ethernet, etc.).

The key-value daemon 622 provides various software components for performing the various functions for performing synchronization between devices including key-value caching and conflict resolution as described with respect to FIGS. 1-5.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
receiving a key-value pair from a first device, the key-value pair including a value corresponding to particular application data of the first device;
determining whether the received key-value pair generates a conflict with one or more other stored key-value pairs;
if a conflict is determined, sending a conflict notification to the first device along with data associated with one or more conflicting key-value pairs;
notifying a second device associated with the first device of the key-value pair;
receiving a request from the second device for the key-value pair; and
sending the key-value pair to the second device.

2. The method of claim 1, further comprising storing the received key-value pair.

3. The method of claim 1, wherein the first device and the second device are both associated with the same user or user account.

4. The method of claim 1, further comprising:
receiving a conflict resolution from the first device.

5. The method of claim 4, where the conflict resolution includes a key-value pair selected as a conflict winner, the key-value pair selected based on the key-valued pair having a latest generation timestamp.

6. The method of claim 4, where the conflict resolution includes a key-value pair selected as a conflict winner, the key-value pair selected based on the key-valued pair having not been identified as associated with an initial synchronization between devices.

7. The method of claim 1, where determining whether the received key-value pair generates a conflict with one or more other stored key-value pairs comprises:
determining that the received key-value paid has an incremental identifier that is out of sequence with one or more other stored key-value pairs.

8. A computer program product, stored on a computer readable medium, comprising instructions that when executed on a first computing device cause the first computing device to perform operations comprising:
sending a key-value pair for an application to a remote location for storage;
receiving notification of a conflict with another stored key-value pair including receiving information about the conflicting key-value pair;
resolving the conflict; and
notifying the remote location of a conflict winner.

9. The computer readable medium of claim 8, where resolving the conflict includes:
determining that the key-value pairs do not represent an initial synchronization between devices;
comparing timestamps for each key-value pair, the timestamp indicating the time the key-value pair was generated on a respective device; and
selecting the key-value pair having the latest timestamp as the conflict winner.

10. The computer readable medium of claim 8, where resolving the conflict includes:
determining that one of the key-value pairs represent an initial synchronization between devices; and
selecting the key-value pair that is not identified as associated with an initial synchronization as the conflict winner.

11. An apparatus comprising:
a computing device configured to provide:
one or more applications;
a key-value daemon for managing application key-value pairs including providing key-value pairs to a remote storage location, receiving key-value pairs from other devices for synchronization, and performing conflict resolution between key-value pairs; and
a key-value cache for storing key-value pairs to be sent to remote storage or received from remote storage.

12. The apparatus of claim 11, where conflict resolution includes:
determining that the key-value pairs do not represent an initial synchronization between devices;
comparing timestamps for each key-value pair, the timestamp indicating the time the key-value pair was generated on a respective device; and
selecting the key-value pair having the latest timestamp as a conflict winner.

13. The apparatus of claim 11, where conflict resolution includes:
determining that one of the key-value pairs represent an initial synchronization between devices; and
selecting the key-value pair that is not identified as associated with an initial synchronization as a conflict winner.

14. A system comprising:
one or more computers configured to perform operations including:
receiving a key-value pair from a first device, the key-value pair including a value corresponding to particular application data of the first device;
determining whether the received key-value pair raises generates a conflict with one or more other stored key-value pairs;
if a conflict is determined, sending a conflict notification to the first device along with data associated with one or more conflicting key-value pairs;
notifying a second device associated with the first device of the key-value pair;
receiving a request from the second device for the key-value pair; and
sending the key-value pair to the second device.

15. The system of claim 14, further comprising storing the received key-value pair.

16. The system of claim 14, wherein the first device and the second device are both associated with the same user or user account.

17. The system of claim 14, further comprising:
receiving a conflict resolution from the first device.

18. The system of claim 17, where the conflict resolution includes a key-value pair selected as a conflict winner, the key-value pair selected based on the key-valued pair having a latest generation timestamp.

19. The system of claim 17, where the conflict resolution includes a key-value pair selected as a conflict winner, the key-value pair selected based on the key-valued pair having not been identified as associated with an initial synchronization between devices.

20. The system of claim 14, where determining whether the received key-value pair generates a conflict with one or more other stored key-value pairs comprises:
determining that the received key-value paid has an incremental identifier that is out of sequence with one or more other stored key-value pairs.

21. A system comprising:
one or more computing devices configured to perform operations including:
sending a key-value pair for an application to a remote location for storage;
receiving notification of a conflict with another stored key-value pair including receiving information about the conflicting key-value pair;
resolving the conflict; and
notifying the remote location of a conflict winner.

22. The system of claim 21, where resolving the conflict includes:
determining that the key-value pairs do not represent an initial synchronization between devices;
comparing timestamps for each key-value pair, the timestamp indicating the time the key-value pair was generated on a respective device; and
selecting the key-value pair having the latest timestamp as the conflict winner.

23. The system of claim 21, where resolving the conflict includes:
determining that one of the key-value pairs represent an initial synchronization between devices; and
selecting the key-value pair that is not identified as associated with an initial synchronization as the conflict winner.
